(19) United States
(12) Patent Application Publication
(10) Pub. No.: US 2021/0357936 A1
(43) Pub. Date: Nov. 18, 2021

(54) SYSTEMS AND METHODS FOR DYNAMIC RULE GENERATION FOR FILTERING CONTEXT-BASED SYSTEM, TRANSACTIONAL, AND BEHAVIORAL DATA

(71) Applicant: JPMORGAN CHASE BANK, N.A., New York, NY (US)

(72) Inventors: Raghuram VUDATHU, Downingtown, PA (US); Gerardo GEAN, Lewisville, TX (US)

(21) Appl. No.: 15/930,316

(22) Filed: May 12, 2020

(51) Int. Cl. G06Q 20/40; G06F 16/23; G06Q 40/02; G06Q 40/00; G06Q 20/32; G06Q 20/10; G06Q 30/02

(52) U.S. Cl. CPC G06Q 20/405; G06F 16/2379; G06Q 40/02; G06Q 30/0215; G06Q 20/326; G06Q 20/108; G06Q 40/12

(57) ABSTRACT

Systems and methods for dynamic rule generation for filtering context-based system, transactional, and behavioral data are disclosed. According to one embodiment, a method for dynamic rule generation for filtering context-based system, transactional, and behavioral data may include: (1) receiving a plurality of tasks, each task based on at least one event type; (2) generating a rule for each of the tasks, wherein the rule specifies one or more conditions based on at least one of an attribute or data field in the event type for the task; (3) identifying a plurality of customers to target for the task based on a customer profile context for each customer; (4) enriching the rule and condition with the customer profile; and (5) publishing the rules and condition to a data lake associated with the event type for the task.

### 1. FIELD OF THE INVENTION

The present disclosure generally relates to systems and methods for dynamic rule generation for filtering context-based system, transactional, and behavioral data.

### 2. DESCRIPTION OF THE RELATED ART

When backend systems review incoming context-based system, transactional and behavioral data for compliance with an offer, the backend system has to monitor context-based system, transactional and behavioral data for all the customers, even though not all of the customers accepted or eligible for the offer. This leads though only few thousands of customers activated or eligible for the offer. There is a huge waste of compute, memory, network and other resources to listen and process unnecessary events.

### SUMMARY OF THE INVENTION

Systems and methods for dynamic rule generation for filtering context-based system, transactional, and behavioral data are disclosed. According to one embodiment, in an information processing apparatus for a financial institution comprising at least one computer processor, a method for dynamic rule generation for filtering context-based system, transactional, and behavioral data may include: (1) receiving a plurality of tasks, each task based on at least one event type; (2) generating a rule for each of the tasks, wherein the rule specifies one or more conditions based on at least one of an attribute or data field in the event type for the task; (3) identifying a plurality of customers to target for the task based on a customer profile context for each customer; (4) enriching the rule and condition with the customer profile; and (5) publishing the rules and condition to a data lake associated with the event type for the task.

In one embodiment, the event type may be an internal event that may include a user action on a website for the financial institution or a user action on a mobile application for the financial institution.

In one embodiment, the event type may be an external event comprising one of a transaction conducted with a third party, a transaction conducted using a financial instrument issued by the financial institution, and transactions totaling a certain amount.

In one embodiment, the condition for a transaction event type may specify at least one of a merchant for the transaction, a transaction amount for the transaction, and a timeframe for the transaction.

In one embodiment, the customer profile that may include a customer location, a type of financial instrument held by the customer, and a transaction history for the customer.

In one embodiment, the method may further include validating the enriched rules and conditions.

In one embodiment, the customer profile context may include at least one of a customer profile, a merchant identifier, a credit card held by the customer, a debit card held by the customer, a type of credit card held by the customer, a type of debit card held by the customer, and a customer electronic device type.

In one embodiment, the method may further include receiving, at one of the data lakes, a completed event; identifying at least one rule met by the completed event; determining that a condition for the identified rule is met; publishing the completed event to an event processing system for the data lake that received the completed event; and updating a task for the completed event with a status.

In one embodiment, the method may further include communicating the updated task status to a fulfilment engine, wherein the fulfilment engine issues a reward or incentive associated with the task in response to the task being complete.

In one embodiment, the method may further include communicating the updated task status to an audit platform.

According to another embodiment, a system for dynamic rule generation for filtering context-based system, transactional, and behavioral data, may include: a targeting engine; an incentive engine; a rules evaluation engine; a task management engine; and a plurality of event data lakes. The task management engine may receive, from a user interface, a plurality of tasks, each task based on at least one event type. The rules evaluation engine may generate a rule for each of the tasks, wherein the rule specifies one or more conditions based on at least one of an attribute or data field in the event type for the task. The targeting engine may identify a plurality of customers to target for the task based on a customer profile context for each customer. The task management engine may enrich the rule and condition with the customer profile and may publish the rules and condition to a data lake associated with the event type for the task.

In one embodiment, the incentive system may validate the enriched rules and conditions before publishing the enriched rules and conditions to the data lake.

In one embodiment, the event type may be an internal event comprising a user action on a website for the financial institution or a user action on a mobile application for the financial institution.

In one embodiment, the event type may be an external event comprising one of a transaction conducted with a third party, a transaction conducted using a financial instrument issued by the financial institution, and transactions totaling a certain amount.

In one embodiment, the condition for a transaction event type may specify at least one of a merchant for the transaction, a transaction amount for the transaction, and a timeframe for the transaction.

In one embodiment, the customer profile may include a customer location, a type of financial instrument held by the customer, and a transaction history for the customer.

In one embodiment, the customer profile context may include at least one of a customer profile, a merchant identifier, a credit card held by the customer, a debit card held by the customer, a type of credit card held by the customer, a type of debit card held by the customer, and a customer electronic device type.

In one embodiment, the system may further include a task process tracking engine, and an event processing system comprising at least one computer process for each data lake. One of the data lakes may receive a completed event, identify at least one rule met by the completed event, determine that a condition for the identified rule is met, and publish the completed event to an event processing system for the data lake. The task process tracking engine may update a task for the completed event with a status.

In one embodiment, the system may further include a fulfillment engine, and the fulfilment engine may issue a reward or incentive associated with the task in response to the task being complete.

In one embodiment, the task management engine may communicate the updated task status to an audit platform.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for dynamic rule generation for filtering context-based system, transactional, and behavioral data according to one embodiment; and

FIG. 2 depicts a method for dynamic rule generation for filtering context-based system, transactional, and behavioral data according to one embodiment.

### DETAILED DESCRIPTION OF PREFERRED EMBODIMENTS

Embodiments are generally directed to systems and methods for dynamic rule generation for filtering context-based system, transactional, and behavioral data.

Gamification platforms, such as those disclosed in U.S. patent application Ser. No. 16/545,566 and U.S. Provisional Patent Application Ser. No. 62/719,960, the disclosures of which are hereby incorporated, by reference, in their entireties, may be used to engage a customer with an organization's products, services, etc. including an organization's mobile application, website, in-person features, etc. Different gamification constructs may be targeted to different customer segments. For example, different constructs that require different sets of activities may be tailored to what a specific customer segment does or does not do, and may be used a way to expose that target customer segment to try other things. Examples of different customer segments include new users versus power users, a customer segment that primarily uses the mobile payment application for online payments only, but not for fuel purchases.

Although many examples herein are in the context of the customer being an end user or a consumer, it should be recognized that a customer may be a company, a merchant, a reseller, or any other suitable entity.

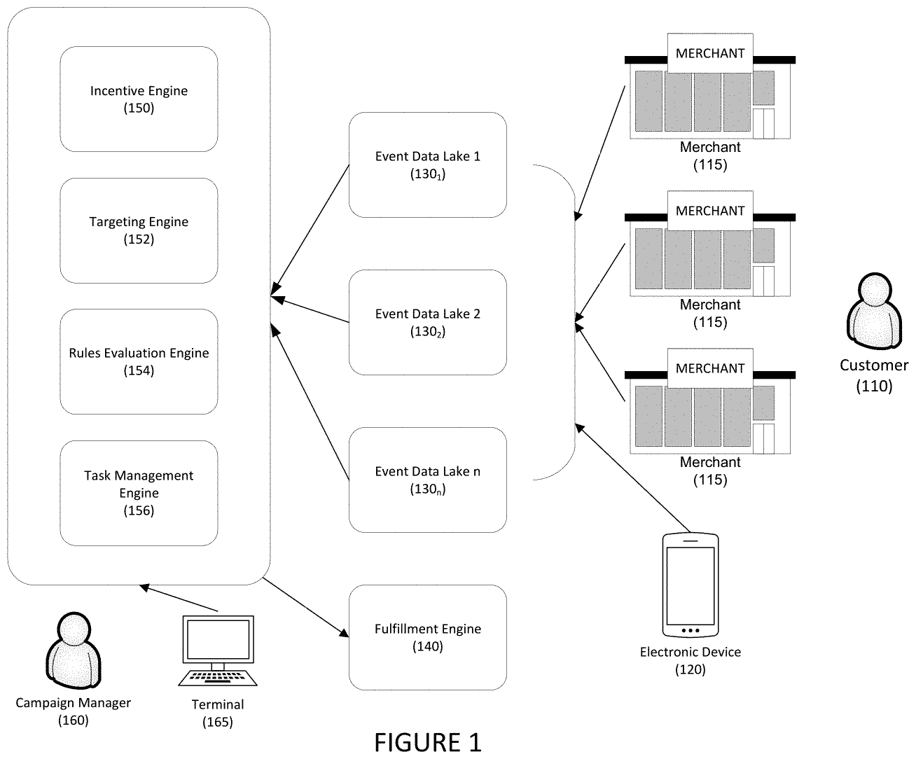

Referring to FIG. 1, system 100 may include a plurality of data sources, such as merchant 115, electronic device 120, etc. that may participate in a transaction with customer 110. Data from data sources 115, 120 may be received in to event data lakes 130₁, 130₂, . . . 130ₙ. System 100 may further include incentive engine 150, targeting engine 152, rules evaluation engine 154, task management engine 156, and task process tracking engine 158.

Task management engine 156 may create tasks, task rules, enrich the task rules, and publish the task rules.

Each event data lakes 130₁, 130₂, . . . 130ₙ may be associated with a different event type. For example, one data lake 130 may be associated with internal events, and a second data lake 130 may be associated with external events. A third data lake 130 may be associated with a hybrid of internal and external events. The events can be of any nature—transactional, behavioral, system, etc.

When one of data lakes 130₁, 130₂, . . . 130ₙ determines that an event meets a task rule condition, the event may be communicated to task process tracking engine 158. Task process tracking engine may mark the progress of the tasks and may send a message to data lakes 130₁, 130₂, . . . 130ₙ to change the status of the task rule from active to completed/invalidated.

Campaign manager 160 may specify the tasks, rules, and targeting criteria for a campaign to incentive system 150. For example, campaign manager 160 may specify the tasks in task management engine 156, the rules in rules engine 154, and targeting criteria in targeting engine 152.

Incentive engine 150 may output an incentive to fulfillment engine 140, which may issue the incentive to customer 110 at merchant 115 or electronic device 120, to the customer's account with the financial institution, may generate a payment, etc. Any suitable type of fulfilment may be provided as is necessary and/or desired.

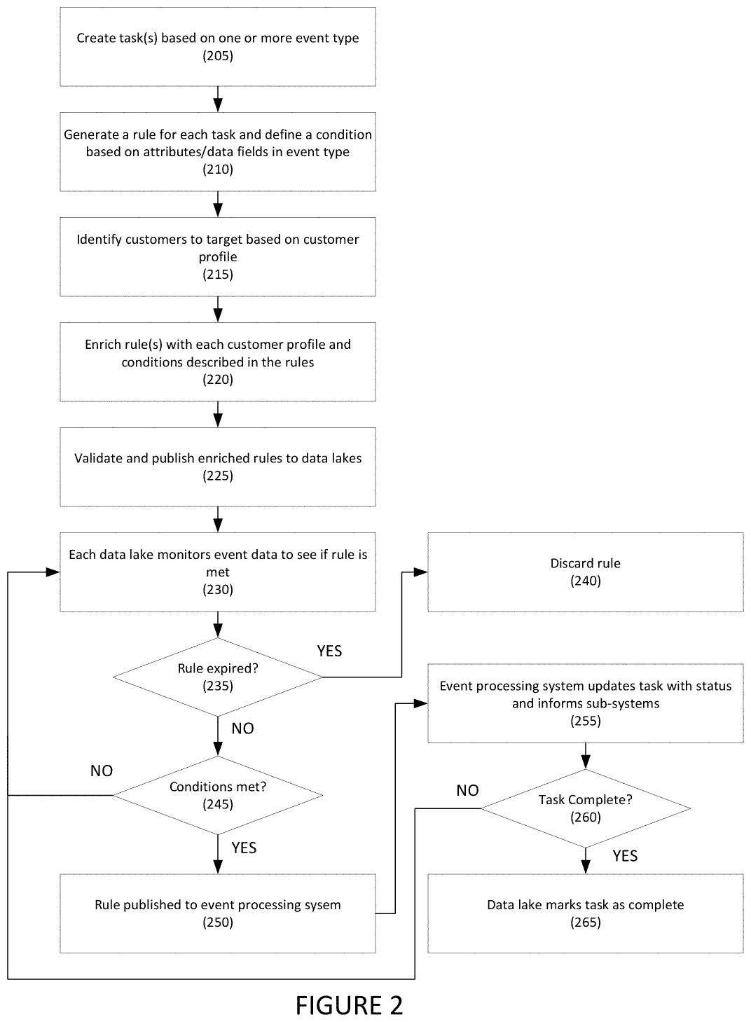

Referring to FIG. 2, a method for dynamic rule generation for filtering context-based system, transactional, and behavioral data is disclosed according to one embodiment. In step 205, a campaign manager may create one or more tasks based on one or more event types. Examples of event types include internal events and external events. For a financial institution, an internal event may be doing something on the financial institution's website, using the mobile application, etc. An external event may be conducting a transaction with a specific financial instrument, with a specific merchant, spending a certain amount, etc. These event types and events are exemplary only; other and additional event types, and events may be used as is necessary and/or desired.

For example, for each task, the data source may be identified. The identification data source assists with identifying the event when the customer conducts the task. Examples include transaction records, audit records, transaction data, behavioral data, other system data, etc.

In step 210, the system may generate a rule for each task. Each rule may include one or more conditions based on the attributes and/or data fields used in the event types.

For example, a rule for an external task may be to conduct a transaction with a credit card; the conditions may specify a merchant to conduct the transaction with, a dollar amount of the transaction, a timeframe for conducting the transaction, etc. The data source may further be identified, as many any optional conditions for the task rule.

In one embodiment, an incentive may be identified and associated with the task.

In step 215, customers may be identified for targeting based on customer profiles. For example, if the rule is based on using a specific credit card, only customers that have the specific credit card may be targeted. Similarly, if the rule involves conducting a transaction with a specific merchant, only customers that have the merchant in their vicinity may be targeted, or only customers that have never used their credit card with the specific merchant may be targeted, etc.

Although in the example above targeting is based on a customer profile, targeting may be based on any context, including, for example, a merchant name/identifier, the merchant geo location where the payment transaction or a payment event, a behavioral event, or a system event occurs, a credit card, debit card, a product that needs promotion, etc.

In step 220, the rule(s) and/or conditions may be enriched with each customer profile. For example, the rule(s) and/or conditions may be enriched based on the context (e.g., targeted customers), start timestamp, end timestamp, any metadata, etc.

In step 225, the rules and/or conditions may be evaluated and validated. For example, the rules and/or conditions may be evaluated and validated to make sure that they are syntactically valid, that the appropriate attribute names/fields names are used, that valid expression language is used in the conditions. When validation passes, the rules and conditions are persisted locally and published to the appropriate data lake for the rule's even type.

For example, expressions may be based on custom operators (e.g., GAND (gamification AND operator), GOR (gamification OR operator), GNOR (gamification negate OR operator), GEQ (Gamification Equals), GLT Gamification Less Than), GMT (Gamification More Than), GADD (Gamification Addition), GSUB (Gamification Subtraction), GMUL (Gamification Multiplication), GDIV (Gamification Division), etc.) and standard mathematical operators and mathematical expression that are defined in the programming languages (e.g., CARD_TYPE GEQ “DEBIT”, AMOUNT GMT 10 etc. or CARD_TYPE=“DEBIT”, AMOUNT>10, etc.).

In step 230, a data lake receives an event, and a check is made to see how many rules are met by the event.

In step 235, the rule's status is checked to see if the rule is expired. If the rule is expired, in step 240, the rule is discarded.

If the rule is not expired, in step 245, the condition(s) for the rule are checked. If the conditions are met, in step 250, the event is published to an event processing system from the data lake.

For example, the rule may have more than one state, including active, invalidated, terminated, expired, completed, suspended, etc. depending on the implementation. The state transition from one state to another may be determined by the life cycle of the rule implementation system.

In step 255, the task process tracking engine may update the task with a new status, and may inform sub-systems. For example, the event processing system may inform fulfilment, audit, analytics, etc. of the status and these sub-systems may update their records and take any action as is necessary and/or desired.

If the rule is complete, the subsystems may fulfill the task by issuing the reward or incentive associated with the task. The rule status may also be updated from one status (e.g., active) to another (e.g., completed, invalidated, etc.), so that further evaluation of the same rule is not processed. This prevents the systems from processing a similar type of message for the same customer over and over, saving many resources, including CPU, memory, network, etc.

In step 260, a check is made to see if the task is complete. If the task is not complete, the process may return to step 230. If the task is complete, the task process tracking engine and/or the data lakes associated with the task may mark the task as complete, and the rule may be discarded.

It should be recognized that although several different embodiments are disclosed, these embodiments are not exclusive. Thus, although certain features may be disclosed in the context of one embodiment, the features may be used any embodiment as is necessary and/or desired.

Hereinafter, general aspects of implementation of the systems and methods of the embodiments will be described.

The system of the embodiments or portions of the system of the embodiments may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

What is claimed is:

1. A method for dynamic rule generation for filtering context-based system, transactional, and behavioral data, comprising:
in an information processing apparatus for a financial institution comprising at least one computer processor:
receiving a plurality of tasks, each task based on at least one event type;
generating a rule for each of the tasks, wherein the rule specifies one or more conditions based on at least one of an attribute or data field in the event type for the task;
identifying a plurality of customers to target for the task based on a customer profile context for each customer;
enriching the rule and condition with the customer profile; and
publishing the rules and condition to a data lake associated with the event type for the task.

2. The method of claim 1, wherein the event type is an internal event comprising a user action on a website for the financial institution or a user action on a mobile application for the financial institution.

3. The method of claim 1, wherein the event type is an external event comprising one of a transaction conducted with a third party, a transaction conducted using a financial instrument issued by the financial institution, and transactions totaling a certain amount.

4. The method of claim 1, wherein the condition for a transaction event type specifies at least one of a merchant for the transaction, a transaction amount for the transaction, and a timeframe for the transaction.

5. The method of claim 1, wherein the customer profile comprises a customer location, a type of financial instrument held by the customer, and a transaction history for the customer.

6. The method of claim 1, further comprising:
validating the enriched rules and conditions.

7. The method of claim 1, wherein the customer profile context comprises at least one of a customer profile, a merchant identifier, a credit card held by the customer, a debit card held by the customer, a type of credit card held by the customer, a type of debit card held by the customer, and a customer electronic device type.

8. The method of claim 1, further comprising:
receiving, at one of the data lakes, a completed event;
identifying at least one rule met by the completed event;
determining that a condition for the identified rule is met;
publishing the completed event to an event processing system for the data lake that received the completed event; and
updating a task for the completed event with a status.

9. The method of claim 8, further comprising:
communicating the updated task status to a fulfilment engine, wherein the fulfilment engine issues a reward or incentive associated with the task in response to the task being complete.

10. The method of claim 8, further comprising:
communicating the updated task status to an audit platform.

11. A system for dynamic rule generation for filtering context-based system, transactional, and behavioral data, comprising:
a targeting engine;
an incentive engine;
a rules evaluation engine;
a task management engine; and
a plurality of event data lakes;
wherein:
the task management engine receives, from a user interface, a plurality of tasks, each task based on at least one event type;
the rules evaluation engine generates a rule for each of the tasks, wherein the rule specifies one or more conditions based on at least one of an attribute or data field in the event type for the task;
the targeting engine identifies a plurality of customers to target for the task based on a customer profile context for each customer;
the task management engine enriches the rule and condition with the customer profile; and
the task management engine publishes the rules and condition to a data lake associated with the event type for the task.

12. The system of claim 11, wherein the incentive system validates the enriched rules and conditions before publishing the enriched rules and conditions to the data lake.

13. The system of claim 11, wherein the event type is an internal event comprising a user action on a website for the financial institution or a user action on a mobile application for the financial institution.

14. The system of claim 11, wherein the event type is an external event comprising one of a transaction conducted with a third party, a transaction conducted using a financial instrument issued by the financial institution, and transactions totaling a certain amount.

15. The system of claim 11, wherein the condition for a transaction event type specifies at least one of a merchant for the transaction, a transaction amount for the transaction, and a timeframe for the transaction.

16. The system of claim 11, wherein the customer profile comprises a customer location, a type of financial instrument held by the customer, and a transaction history for the customer.

17. The system of claim 11, wherein the customer profile context comprises at least one of a customer profile, a merchant identifier, a credit card held by the customer, a debit card held by the customer, a type of credit card held by the customer, a type of debit card held by the customer, and a customer electronic device type.

18. The system of claim 11, further comprising a task process tracking engine, and an event processing system comprising at least one computer processor for each data lake, wherein:
one of the data lakes receives a completed event;
the data lake identifies at least one rule met by the completed event;
the data lake determines that a condition for the identified rule is met;
the data lake publishes the completed event to an event processing system for the data lake;
the task process tracking engine updates a task for the completed event with a status.

19. The system of claim 18, further comprising a fulfillment engine, wherein the fulfilment engine issues a reward or incentive associated with the task in response to the task being complete.

20. The system of claim 18, wherein the task management engine communicates the updated task status to an audit platform.
